(19) United States
(12) Patent Application Publication
(10) Pub. No.: US 2013/0265006 A1
(43) Pub. Date: Oct. 10, 2013

(54) VEHICLE-SIDE SOCKET OF A CHARGING CONNECTOR, IN PARTICULAR FOR INDUSTRIAL VEHICLES

(71) Applicant: SCHALTBAU GMBH, Muenchen (DE)

(72) Inventor: Jerzy FRACZEK, Muenchen (DE)

(73) Assignee: Schaltbau GmbH, Muenchen (DE)

(21) Appl. No.: 13/857,959

(22) Filed: Apr. 5, 2013

(30) Foreign Application Priority Data
Apr. 5, 2012 (DE) 10 2012 007 047.0

(51) Int. Cl. H02J 7/00; B60L 11/18

(52) U.S. Cl. CPC H02J 7/0042; B60L 11/1809
USPC 320/109

(57) ABSTRACT

The invention relates to a vehicle-side socket of a charging connector, in particular for industrial vehicles, comprising a first main contact and a second main contact, which are adapted to be connected to a charging connector, as well as an auxiliary contact, which, in the operating condition of the vehicle, with the charging connector removed, is electrically connected to one of the main contacts via a contact bridge, the contact bridge having a first end captively connected to the auxiliary contact and being adapted to be transferred from a first position, at which said main contact is free for attaching the charging connector thereto, to a second position, at which the contact bridge connects the auxiliary contact to said main contact.

The invention relates to a vehicle-side socket of a charging connector, in particular for industrial vehicles, comprising a first main contact and a second main contact, which are adapted to be connected to a charging connector, as well as an auxiliary contact, which, in the operating condition of the vehicle, with the charging connector removed, is electrically connected to one of the main contacts via a contact bridge.

Such vehicle-side sockets, which serve to connect a vehicle accumulator with a source of electric energy, are known to a large extent from the prior art. In order to guarantee that the charging connector is removed from the socket, when the charging process has been finished, and in particular when the vehicle is in operation, an auxiliary contact, which is connected to a control unit, has to be connected to at least one of the main contacts via a displaceable contact bridge after the removal of the charging connector. Through this electric connection of the auxiliary contact with one of the main contacts, a specific signal current is tapped by the auxiliary contact and supplied to the control unit, which, in turn, controls the electric drive of the vehicle in accordance with this signal current. Thus, the drive is enabled when a specific signal current value exists and disabled when the signal current value is too low. This safety device guarantees that no plug is clamped to the vehicle, when the vehicle is in operation. It is thus possible to avoid damage that may be caused to the vehicle and the charging devices as well as to objects and persons in the vicinity thereof, when the vehicle is started.

EP 1 014 510 B1, for example, discloses a charging device in the case of which a third main contact is arranged next to two first and second main contacts, which third main contact can be covered by attaching thereto a separate, cap-like element which is adapted to be attached to the main contacts. This embodiment is, however, disadvantageous insofar as this cap-like element is configured as a loose part. Hence, this cap-like element may get easily lost, especially during the charging period of the vehicle accumulator. Such a loss would make the vehicle unsuitable for use until a replacement cap is available. Moreover, the operator may in this case be tempted to himself create a bridging connection and this, in turn, may lead to the installed parts being damaged and to an increased risk of injuries.

It is therefore the object of the present invention to provide a vehicle-side socket of a charging connector, which minimizes the risk of losing the contact bridges provided for the purpose of bridging and increases safety when the vehicle is in operation.

According to the present invention, this object is achieved in that the contact bridge has a first end captively connected to the auxiliary contact and is adapted to be transferred from a first position, at which one of the main contacts is free for attaching the charging connector thereto, to a second position, at which the contact bridge connects the auxiliary contact to said one of the main contacts.

This has the effect that the contact bridge is connected in a stationary manner to the auxiliary contact of the vehicle-side socket. The contact bridge is thus permanently coupled to the socket and, consequently, the vehicle during charging of the vehicle accumulator as well as during the operating time of the vehicle. In addition, due to the displaceability of this contact bridge between the two contact bridge positions, the bridging function can easily be adjusted when the vehicle is in the operating condition.

Additional features, whose advantages will be explained briefly hereinbelow, are disclosed in the subclaims.

According to an advantageous embodiment, the first end of the contact bridge merges with a first contact pin connected to the auxiliary contact, and/or, for contacting said one of the main contacts at the second position, a second end of the contact bridge merges with a second contact pin. By means of this embodiment of the contact bridge, coupling with the auxiliary contact and with said one of the main contacts is accomplished in a structurally simple manner. In addition, the two spatially separated contact areas are clearly associated with the respective contacts.

When the first and second main contacts are configured as two contact bushings arranged, with respect to their longitudinal axes, substantially parallel to one another, and when the first contact pin and/or the second contact pin is/are, in turn, arranged, with respect to its/their longitudinal axis/axes, substantially parallel to these contact bushings, this will allow a spatially compact structural design of the subject matter according to the present invention. The fact that the main contacts are configured as contact bushings offers, in turn, the advantage that the contact surfaces are shielded towards the outside and are easily accessible to the second contact pin.

When, for switching the contact bridge from the first to the second position, the contact bridge is adapted to be displaced axially along the longitudinal axis of the first contact pin from the first position to a first intermediate position and to be rotated to a second intermediate position, at which the second contact pin is adapted to be inserted into said one of said main contacts, said second contact pin being also axially displaceable from said second intermediate position to the second position, the first and second positions will be clearly delimited from one another through the additional movements of the contact bridge.

It will also be of advantage when the first contact pin, which is connected to the auxiliary contact, is axially secured in position by means of a spring at the first as well as at the second position. Unintentional movements of the contact bridge will be avoided in this way.

When the contact bridge includes between the first and second ends a contact flange, which extends transversely to the first and/or second contact pin, the two ends can easily be connected and the installation space can be reduced still further.

When the contact bridge is supported such that it is rotatable about the longitudinal axis of the first contact pin, switching of the contact bridge from the first to the second position is simplified still further.

Making reference to one embodiment, the present invention will be explained in more detail with the aid of figures in a plurality of drawings, in which

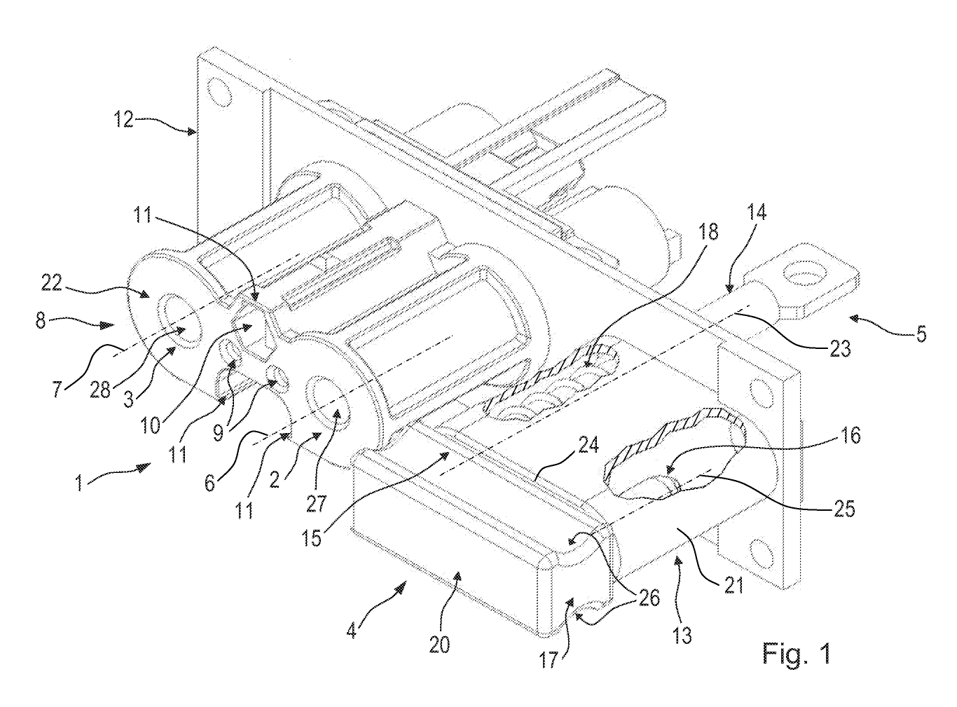

FIG. 1 shows an isometric view of the vehicle-side socket of a charging connector according to the present invention at a first position, at which the main contacts are free for attaching the charging connector thereto.

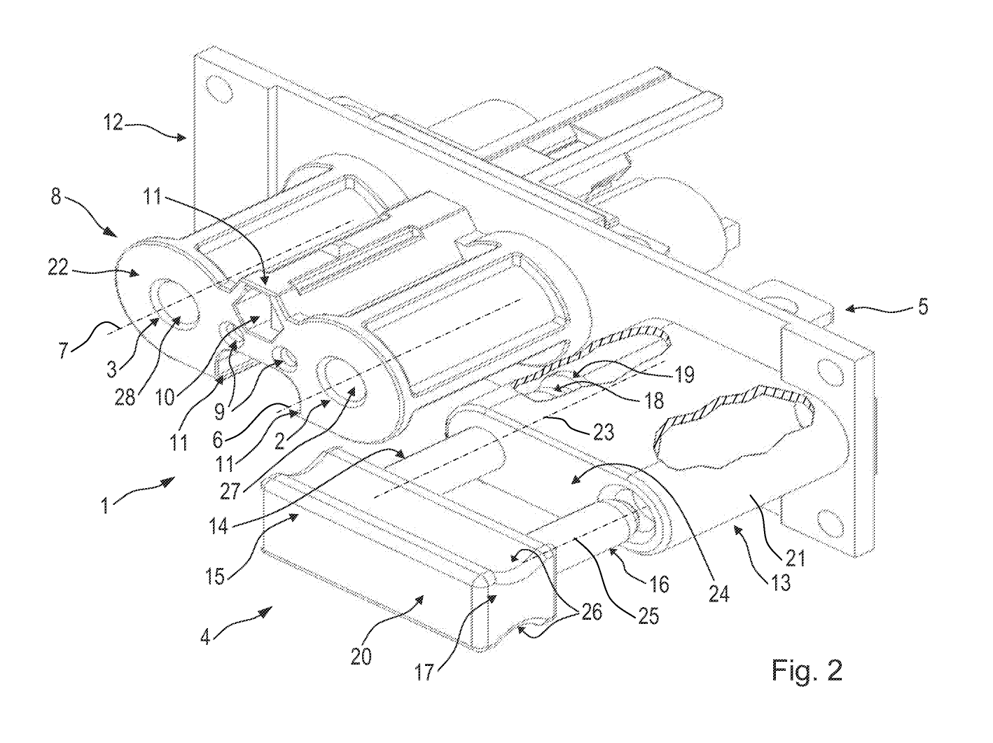

FIG. 2 shows the vehicle-side socket according to FIG. 1 at a first intermediate position, at which the contact bridge is axially displaced in comparison with the first position.

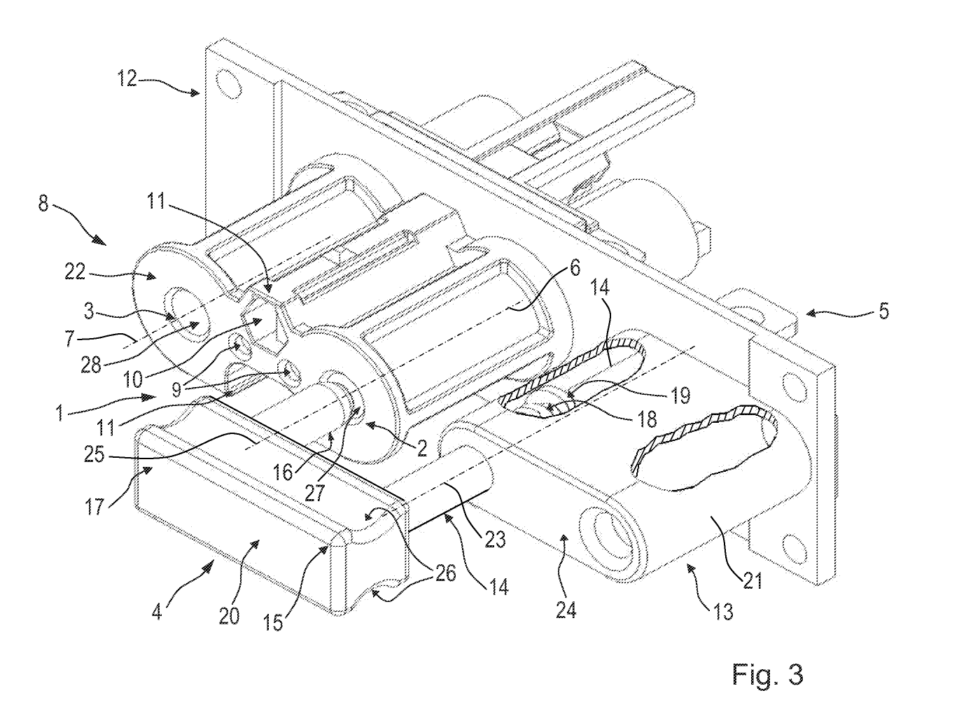

FIG. 3 illustrates the second intermediate position of the vehicle-side socket according to FIG. 1, at which the contact bridge has additionally been rotated in comparison with the first intermediate position.

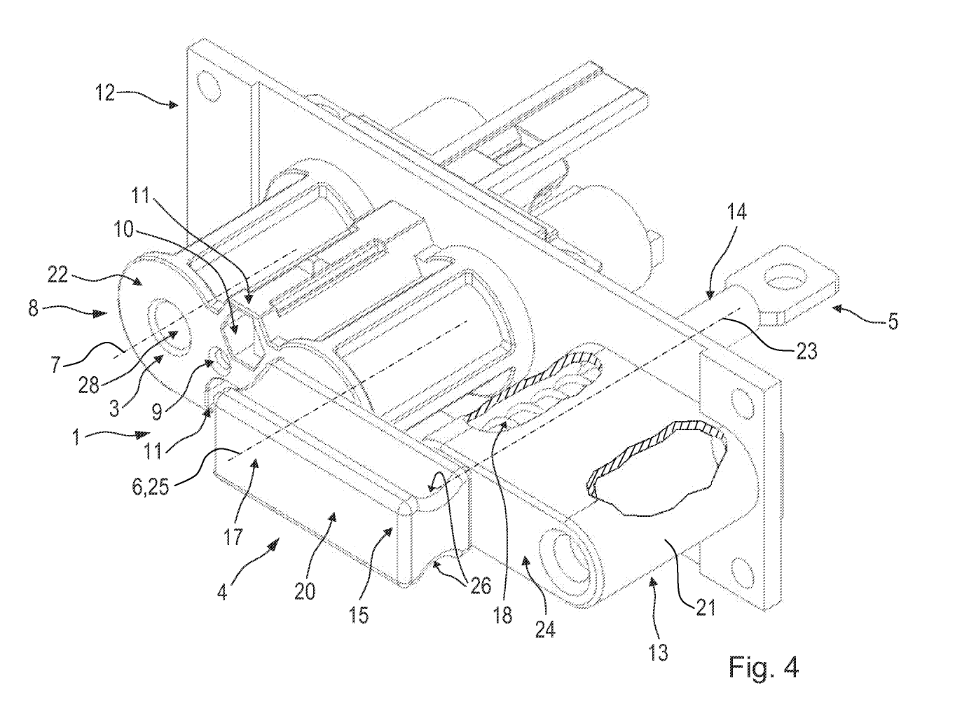

FIG. 4 shows the contact bridge of the vehicle-side socket of the preceding figures at a second position, at which the charging connector is separated from the main contacts and the vehicle is freed for operation.

The figures are only of a schematic nature and serve merely the purpose of making the present invention understandable. Identical elements are provided with identical reference numerals.

FIG. 1 shows a vehicle-side socket 1 of a charging connector comprising a first main contact 2 as well as a second main contact 3 according to the present invention, said main contacts 2, 3 being adapted to be connected to an auxiliary contact 5 via a contact bridge 4.

The two main contacts 2, 3 are configured as contact bushings arranged substantially parallel to one another with respect to their longitudinal axes 6, 7 and supported in the interior of a plug reception means 8. Inner surfaces 27, 28 of the contact bushings of the two main contacts 2, 3 are accessible for mating contacts, such as the pole pins of a plug, via openings in an outer end face 22 of the plug reception means 8. For charging the accumulator, with the plug connected, with electric energy, a large-area connection between these inner surfaces of the contact bushings of the main contacts 2, 3 and the outer surfaces of the pins to be contacted, e.g. the pins of the plug, is established in the usual way.

In a space between the contact bushing of the first main contact 2 and the contact bushing of the second main contact 3, additional contact areas can be provided. For example, pilot contact reception means 9 for receiving therein one or a plurality of pilot contact pins, a coding pin reception means 10 for receiving therein a coding pin and/or connections for supplying air/liquid may additionally be provided. Furthermore, the plug reception means 8 has arranged thereon a plurality of guide flanges 11, which serve to guide the plug when the plug is being applied to the plug reception means 8. The structural design of the plug reception means 8 corresponds preferably to the DIN 43589-1 standard. For the purpose of fastening to the vehicle, the plug reception means 8 is fixed to a base plate 12, said base plate 12 including mounting areas so that it can be mounted on the vehicle. The longitudinal axes 6, 7 of the two main contacts 2, 3 extend here transversely to, in particular perpendicular to the plate plane of the base plate 12.

Next to the plug reception means 8 accommodating the first and second main contacts 2, 3, an auxiliary contact reception means 13 is arranged, which is preferably implemented separately from the plug reception means 8 and fixed to the base plate 12 as well. This auxiliary contact reception means 13 serves to support a first contact pin 14 connected to the auxiliary contact 5, said first contact pin 14 being configured as a rod and defining a first end 15 of the contact bridge 4. The first contact pin 14 is rigidly connected to the first end 15. With respect to its longitudinal axis 23, the first contact pin 14 is arranged substantially parallel to the longitudinal axes 6, 7 of the first and second main contacts 2, 3. In addition to the shown arrangement of the first contact pin 14 and, consequently, of the auxiliary contact reception means 13 laterally next to the plug reception means 8 and the main contacts 2, 3, the first contact pin as well as the auxiliary contact reception means 13 may also be arranged below or above the plug reception means 8. The axial position of the first contact pin 14, i.e. the position in the direction of its longitudinal axis, is secured by a spring element 18 configured as a spiral spring.

As can be seen from FIG. 2 in a particularly clear manner, this spring element 18 rests with a first spring end on an inner side of an end face 24 of the auxiliary contact reception means 13 and with a second spring end, located opposite the first spring end, on a support ring 19 fixed to the first contact pin 14. Due to the spring force of the spring 18, the first contact pin 14 of the auxiliary contact 5 as well as the contact bridge 4 are secured in position at the position shown in FIG. 1.

At a second end 17, located opposite the first end 15, the contact bridge 4 has additionally formed thereon a second, rod-shaped contact pin 16, which, with respect to its longitudinal axis 25, is also arranged substantially parallel to the longitudinal axes 6, 7 of the first and second main contacts 2, 3 and thus also parallel to the longitudinal axis 23 of the first contact pin 14. The two ends 15 and 17 of the contact bridge 4 are connected via a flange portion 20 extending transversely to the longitudinal axes 23, 25 of the first and second contact pins 14, 16. This flange portion 20 of the contact bridge 4 has on the outer side thereof gripping surfaces 26 for ease of handling, which are preferably covered by an electrically insulating material. In the interior, however, a web of electrically conductive material is provided, by means of which the two ends 16, 17 are electrically coupled.

When, after charging the vehicle accumulator, the vehicle is to be restarted, the contact bridge 4 is switched from the first position shown in FIG. 1 to the second position shown in FIG. 4. To this end, the contact bridge 4 is first axially displaced, against the spring force, along the longitudinal axis 23 of the first contact pin 14 until the second contact pin 16 has been fully removed from the auxiliary contact reception means 13 and projects thus with its front free end face outwards beyond the outer surface of the end face 24 of the auxiliary contact reception means 13. At the resultant first intermediate position (that can be seen in FIG. 2), the spring element 18 is in a compressed state. Subsequently, the contact bridge 4 is pivoted about the longitudinal axis 23 of the first contact pin 14 to a second intermediate position (that can be seen in FIG. 3) until the longitudinal axis of the second contact pin 16 is symmetrical with respect to the longitudinal axis 6 of the first main contact 2.

In order to reach the second position, which is shown in FIG. 4 and which allows the vehicle to be operated, the contact bridge is displaced axially along the longitudinal axis 23 of the first contact pin 14 so as to insert the second contact pin 16 into the contact bushing of the first main contact 3. Finally, the auxiliary contact 5 reassumes an axial position corresponding to the first position, the only difference being that it has been rotated by the angle of displacement, which is here 180°.

The outer surface of the end face 24 of the auxiliary contact reception means 13 as well as the outer end face 22 of the plug reception means 8 include planar portions which, at the first and/or second position of the contact bridge 4, come into contact with a contact area on the flange portion 20 of the contact bridge 4.

Alternatively to the embodiments shown, the second contact pin 16 of the contact bridge 4 may also be inserted into the contact bushing of the second main contact 3 at the second position. This could easily be accomplished simply by extending the flange portion 20.

As regards the auxiliary contact reception means 13, the latter is, according to a further preferred embodiment, so conceived that it is implemented with a closed circumferential surface 21 so as to prevent the contact pins 14, 16 from being acted upon from outside at the first and second positions of the contact bridge 4.

1. A vehicle-side socket (1) of a charging connector, in particular for industrial vehicles, comprising a first main contact (2) and a second main contact (3), which are adapted to be connected to a charging connector, as well as an auxiliary contact (5) which, in the operating condition of the vehicle, with the charging connector removed, is electrically connected to one of the main contacts (2, 3) via a contact bridge (4), characterized in that the contact bridge (4) has a first end (15) captively secured to the auxiliary contact (5) and is adapted to be transferred from a first position, at which said main contact (2, 3) is free for attaching the charging connector thereto, to a second position, at which the contact bridge (4) connects the auxiliary contact (5) to said main contact.

2. A vehicle-side socket (1) according to claim 1, characterized in that the first end (15) of the contact bridge (4) merges with a first contact pin (14) connected to the auxiliary contact (5), and/or that, for contacting said one of the main contacts (2, 3) at the second position, a second end (17) of the contact bridge (4) merges with a second contact pin (16).

3. A vehicle-side socket (1) according to claim 2, characterized in that the first and second main contacts (2, 3) are configured as two contact bushings arranged, with respect to their longitudinal axes (6, 7), substantially in parallel side by side and/or parallel to a longitudinal axis (23, 25) of the first contact pin (14) and/or of the second contact pin (16).

4. A vehicle-side socket (1) according to claim 2, characterized in that, for switching from the first position to the second position, the contact bridge (4) is adapted to be displaced axially along the longitudinal axis (23) of the first contact pin (14) to a first intermediate position and to be rotated to a second intermediate position, the second contact pin (16) being displaceable from said second intermediate position to the second position.

5. A vehicle-side socket (1) according to claim 1, characterized in that the auxiliary contact (5) is secured in position by means of a spring element (18) at the second position and at the first position.

6. A vehicle-side socket (1) according to claim 2, characterized in that the contact bridge (4) includes a flange portion (20) between the first and second ends (15, 17), said flange portion (20) being oriented transversely to the longitudinal axis (23, 25) of the first and/or second contact pin (14, 16).

7. A vehicle-side socket (1) according to claim 2, characterized in that the contact bridge (4) is supported such that it is rotatable about the longitudinal axis (23) of the first contact pin (14), and that, for switching the contact bridge (4) from the first position to the second position, said contact bridge (4) is rotated about the longitudinal axis (23) of the first contact pin (14).
